(19) United States
(12) Patent Application Publication
(10) Pub. No.: US 2003/0212353 A1
(43) Pub. Date: Nov. 13, 2003

(54) Apparatus and method for applying streaming kneading massage strokes

(76) Inventor: Rocky Kahn, Oakland, CA (US)

Correspondence Address: Porter. Wright, Morris & Arthur LLP, ATTN: Intellectual Property Department, 28th Floor, 41 South High Street, Columbus, OH, 43215-6194, US

(21) Appl. No.: 10/142,144

(22) Filed: May 9, 2002

(51) Int. Cl. A61H 15/00; A61H 7/00

(52) U.S. Cl. 601/99; 601/102; 601/103; 601/112; 601/116

(57) ABSTRACT

A massage device for manipulating a user includes at least first and second manipulators each adapted to engage the user. A transfer assembly carries the first and second manipulators and moves the first and second manipulators along successive first and second open paths of contact on the user, respectively. The first and second open paths of contact each have engagement and disengagement points. The engagement and disengagement points of the first open path of contact are each within about two inches of the engagement and disengagement points of the second open path of contact, respectively. Various embodiments of the device are disclosed such as a handheld device wherein the manipulators are on rotating turrets and devices wherein the manipulators are moved by a belt.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to an apparatus and method for applying a massage to a person's body and, more particularly, to such an apparatus and method for applying a streaming kneading massage on the desired portion of the person's body.

### BACKGROUND OF THE INVENTION

Massage practitioners tend to avoid closed kneading paths and instead favor linear or curvilinear open paths. As shown in FIGS. 1 and 2, these open paths are created by stroking the user with the right hand 1 from point A to point B. Then, placing the left hand 2 at point A and lifting the right hand 1 from point B only after left hand 2 has made contact with point A. Then stroking the user with the left hand 2 from point A to point B while the right hand 1 recovers to point A without contacting user. Then, placing the right hand 1 at point A and lifting left hand 2 from point B only after the right hand 1 has made contact with point A. This cycle repeats.

One device designed to provide a kneading massage is the Vimed Shiatsu neck massager manufactured by Vimed, Inc., Charlotte, N.C. This device applies an open kneading stroke to the user. As best shown in FIG. 3, the kneading action is provided by using a pair of rotating turrets 4 located on opposed sides of the user's neck. Each turret 4 consists of an off-center post manipulator 6 mounted on a rotating disc 8. These manipulators stroke the user's neck in the superior to inferior direction or vice versa. Because the manipulators are mounted on a rotating disc 8, the position of the manipulators 6 while in contact with the user is along an arc which curves into the user. This path causes the manipulators 6 to push deeply into the user's neck in the middle part of the stroke which can cause pain. As best shown in FIG. 4, the force applied slowly ramps up at the engagement point, increases to a maximum force at the center of the stroke, and decreases until it slowly ramps down to the disengagement point. As can be seen, there is a large variation in force throughout the stroke path including the central region of the stroke path. If the two turrets are spaced farther apart, the pain can be eliminated but the overall intensity can become so low as to lose the effectiveness of the massage. The Vimed Shiatsu neck massager also does not maintain continuous contact with the user which is perceived as an undesirable discontinuity in the massage.

Another device designed to provide a kneading massage is Family Corp. model FMC-300 massage chair. This device uses bent rotating axles and linkages to generate an ovaloid kneading stroke against the user's back. This device provides a closed path which is straightforward to generate but is suboptimal in terms of comfort to the user.

While these prior devices may adequately perform some type of kneading massage stroke, they do not accurately produce the action of a kneading stroke produced by a massage practitioner. Accordingly, there is a need in the art for a massage device which produces a kneading stroke which maintains the manipulators at a substantially constant pressure against the user, maintains continuous contact between the device and the user, and/or applies the kneading stroke along an open path.

### SUMMARY OF THE INVENTION

The present invention provides a massage device which overcomes at least some of the above-noted problems of the related art. According to the present invention, a massage device for manipulating a user includes, in combination, a first manipulator adapted to engage the user; a second manipulator adapted to engage the user, and a transfer assembly carrying the first and second manipulators and moving the first and second manipulators along successive first and second open paths of contact on the user respectively. The first and second open paths of contact each have engagement and disengagement points. The engagement and disengagement points of the first open path of contact are each within about two inches of the engagement and disengagement points of the second open path of contact respectively.

From the foregoing disclosure and the following more detailed description of various preferred embodiments it will be apparent to those skilled in the art that the present invention provides a significant advance in the technology and art of massage devices. Particularly significant in this regard is the potential the invention affords for providing a high quality, reliable, low cost assembly which can apply an streaming kneading massage to the user. Additional features and advantages of various preferred embodiments will be better understood in view of the detailed description provided below.

### BRIEF DESCRIPTION OF THE DRAWINGS

These and further features of the present invention will be apparent with reference to the following description and drawing, wherein:

FIG. 1 is a diagrammatic view of a massage practitioner applying a first portion of a kneading massage stroke to a user;

FIG. 2 is a diagrammatic view of the massage practitioner of FIG. 1 applying a second portion of the kneading massage stroke to the user;

FIG. 3 is a diagrammatic view of a portion of a prior art massaging device;

FIG. 4 is a graph showing a force applied to a user by the device of FIG. 3 over a stroke path;

FIG. 5 is an perspective view of a massage device according to a first embodiment of the present invention;

FIG. 6 is a graph showing a force applied the a user by the device of FIG. 3 over a stroke path;

FIGS. 7 to 9 are elevational views of a massage device according to a second embodiment of the present invention;

FIGS. 10 and 11 are elevational views of a massage device according to a variation of the massage device of FIGS. 7 to 9 wherein linear motion actuators are provided to adjust the stroke length of the device;

FIGS. 12 and 13 are elevational views of a massage device according to a third embodiment of the present invention;

FIGS. 14 and 15 are elevational views of a massage device according to a variation of the massage device of FIGS. 12 and 13 wherein a flexing spine is provided to adjust the force applied by the device;

FIG. 16 is a diagrammatic view of a perspective view of a massage device according to a fourth embodiment of the present invention;

FIG. 17 is a diagrammatic view showing a stroke A and a stroke B applied by any of the devices of FIGS. 7 to 16;

FIG. 18 is a diagrammatic view showing a preferred geometric relationship for the devices of FIGS. 7 to 16 wherein the maximum distance between any manipulator and any point on an open path of contact with the user is less than a total length of the open path of contact;

FIG. 19 is a diagrammatic view of a preferred geometric relationship for the devices of FIGS. 7 to 16 wherein the maximum distance between any manipulator and any point on an open path of contact with the user is less than a diameter of an arced section of the contact path;

FIG. 20 is a diagrammatic view of a preferred geometric relationship for the devices of FIGS. 7 to 16 wherein the open path of contact is generally defined by a relatively large diameter arc and engagement and disengagement points at the ends of the open path of contact are defined by relatively small diameter arcs tangent to the large diameter arc;

FIG. 21 is a diagrammatic view of massage device according to a fifth embodiment of the present invention wherein manipulators have separate, independent drive motors;

FIG. 22 is a diagrammatic view of a massage device according to a variation of the device of FIG. 21 wherein the separate drive motors are concentric to reduce the number of required pressure pistons; and

FIG. 23 is a fragmented perspective view of a massage device according to a sixth embodiment of the present invention.

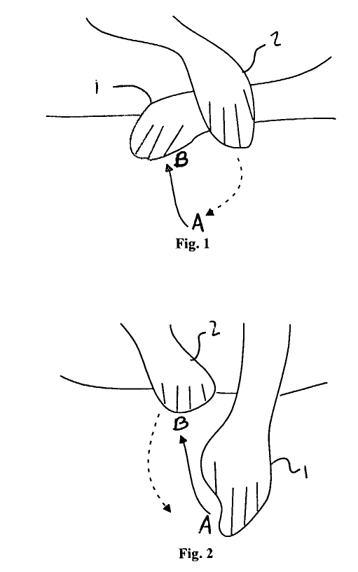

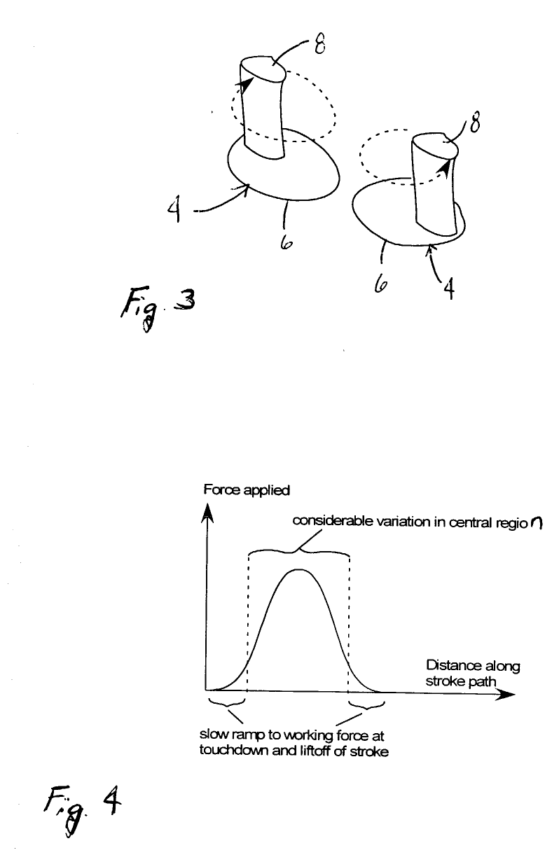

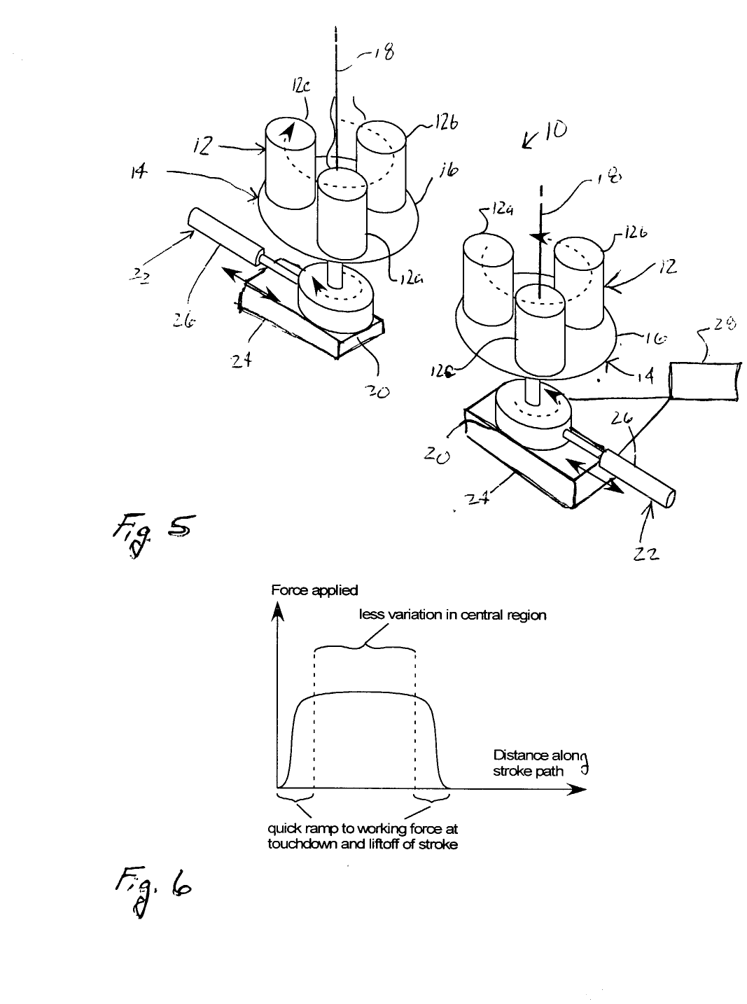

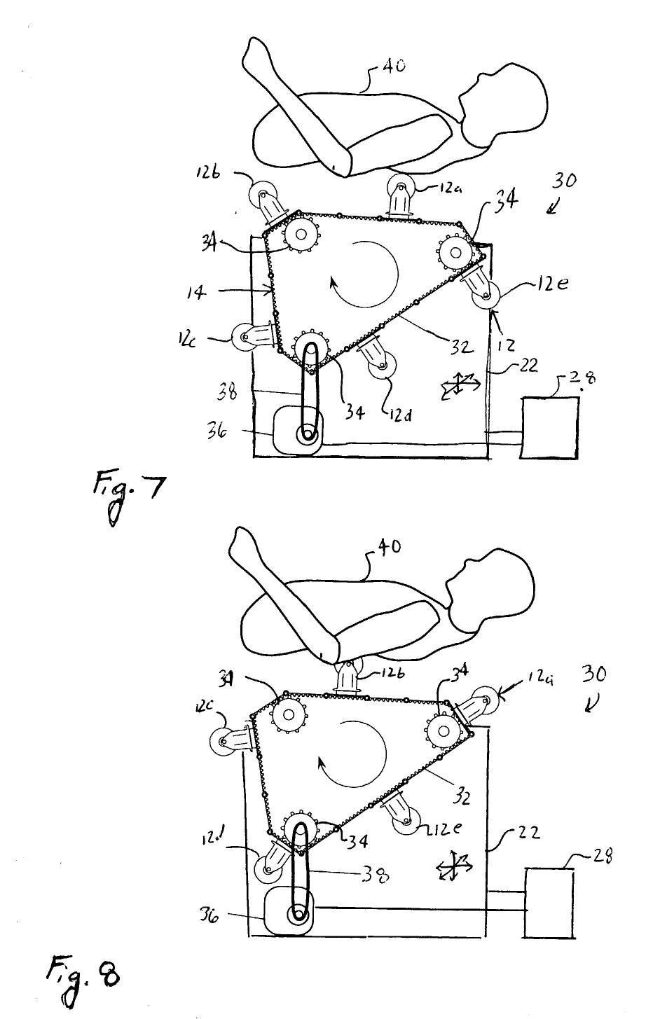

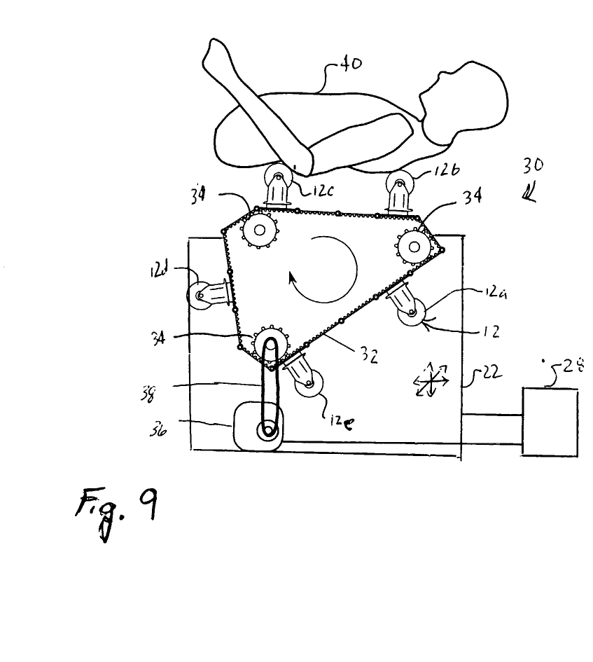

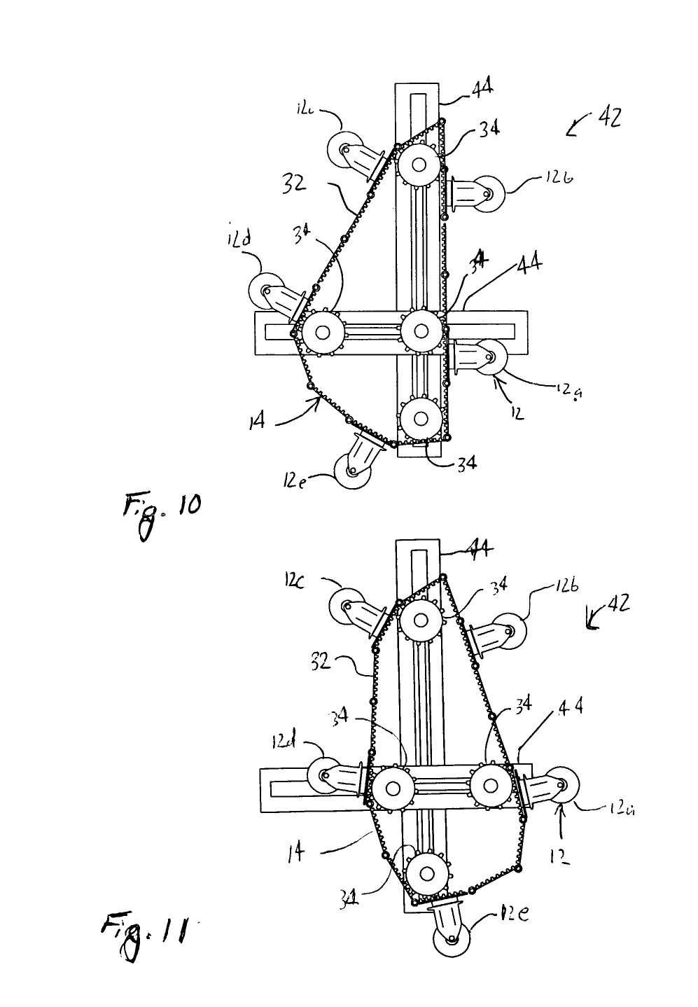

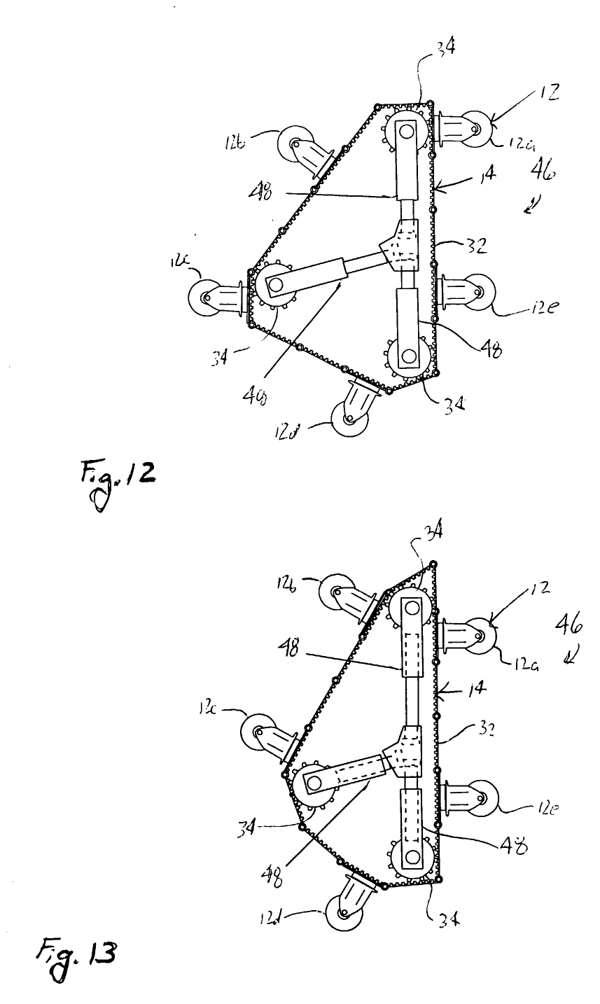

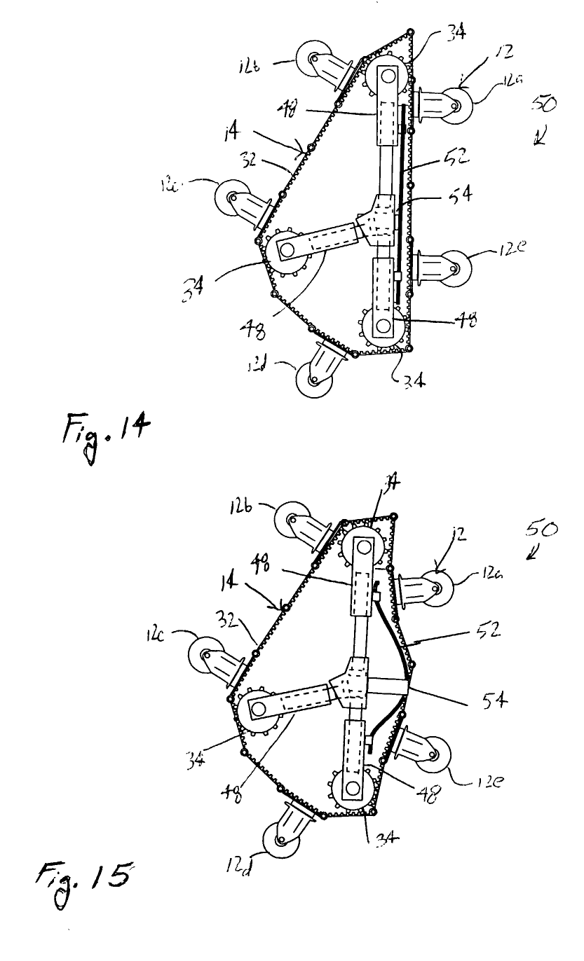

It should be understood that the appended drawings are not necessarily to scale, presenting a somewhat simplified representation of various preferred features illustrative of the basic principles of the invention. The specific design features of a massage device as disclosed herein, including, for example, specific manipulator types, transfer assembly types, and translator types, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the massage device illustrated in the drawings. In general, up or upward refers to an upward direction within the plane of the paper in FIG. 7 and down or downward refers to a downward direction within the plane of the paper in FIG. 7.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved massage devices disclosed herein. The following detailed discussion of various alternative and preferred embodiments illustrate the general principles of the invention with reference to several specific embodiments of the present invention. Other embodiments suitable for other applications will be apparent to those skilled in the art given the benefit of this disclosure.

FIG. 5 illustrates a massage device 10 for manipulating and/or massaging a recipient or user according to a first embodiment of the present invention. The illustrated massage device 10 applies an open stroking path to the user while maintaining continuous contact. This massage device 10 can advantageously utilized as a handheld neck massager. The massage device 10 includes a plurality of manipulators 12 adapted to engage the user and a transfer assembly 14 which carries the manipulators 12 and moves the manipulators 12 along successive open paths of contact on the user.

The illustrated transfer assembly 14 is in the form of two freely rotating turrets which are spaced apart on opposite sides of the user. It is noted that a single turret or more than two turrets can alternatively be utilized according to the present invention. Each turret includes a disc 16 which is rotatable about a central axis of rotation 18 by an electric motor 20 or other suitable drive element. The manipulators 12 are secured to the disc 16 for rotation therewith. The illustrated manipulators 12 are post type manipulators which extend from the disc 16 substantially parallel to the axis of rotation 18 but spaced apart from the axis of rotation 18. It is noted that other types of manipulators 12 can be utilized. The illustrated embodiment has three manipulators 12a, 12b, 12c equally spaced-apart about the axis of rotation 18 but two or more manipulators 12 can be utilized within the scope of the present invention.

A translator 22 moves the transfer assembly 14 and manipulators 12 into desired positions relative to the user. The illustrated translator 22 includes a pair of sleds 24 which are driven by pneumatic pistons 26 to push the manipulators 12 into engagement with the user with a constant or variable force. It is noted that the sled 24 can be alternatively driven by any suitable drive means such as, for example, an electric motor, a spring, and/or a hydraulic piston. The sled 24 may itself be mounted on further translation devices capable of moving over the user's body in other axes, that is, in axes other than the axis extending toward and away from the user in which the sled 24 moves.

Preferably, a controller 28 is in communication with the transfer assembly motors 20 and the translator pneumatic pistons 26 to automatically control the massage applied to the user. The controller 28 is preferably of the programmable type. The resultant massage device 10 is able to apply either constant or dynamically changeable force to the user.

It should be appreciated that each of the manipulators 12 moves along a circular translation path including an open path of contact with the user and an open path of non-contact with the user. The largest distance between each of the manipulators and a nearest point along its open path of contact at any point along the translation path is preferably less than a total length of its open path of contact. The translation path preferably has a diameter which is at least 5% longer than the largest distance between the manipulator and a nearest point along the open path of contact at any point along the translation path. It is noted that a first vector can be defined as a vector extending from the engagement point of the open path of contact to the disengagement point of the open path of contact and a second vector can be defined as a vector extending normal to the user at a midpoint of the first open path of contact. Preferably, the open path of contact has at least one change in curvature when projected onto a plane formed by the first and second vectors, and more preferably the open path of contact has at least one section with a continuous change of curvature when projected onto the plane.

As best shown in FIG. 6, the above described massage device 10 applies a substantially constant force curve where a therapeutic level of force is applied over a longer path length without exceeding force levels which cause the user pain. Notably, the device has a very quick ramp up from the engagement point and a very quick ramp down to the disengagement point to increase the distance of the stroke path which is at the therapeutic level. Most notably, the central region of the stroke path, which includes about 80% of the total length of the stroke path, is substantially constant at the therapeutic level within preferably about 50%, with more preferably about 25%, and within even more preferably about 12% of maximum contact pressure along the central portion. It is noted that means for providing dynamic intensity control can alternatively be provided as disclosed in U.S. patent application Ser. No. ______ , titled “Manipulation Device With Dynamic Intensity Control”, and filed the same day as the present invention, the disclosure of which is expressly incorporated herein in its entirety by reference.

FIGS. 7 to 9 illustrate a massage device 30 according to a second embodiment of the present invention. The massage device 30 according to the second embodiment is substantially the same as the device 10 according to the first embodiment except as described herein below and like references numbers are utilized to indicate like structure. The transfer assembly 14 is in the form of a tracked wheel system having a flexible belt 32 extending about plurality of rotatable wheels or pulleys 34 for rotation thereabout. The illustrated belt 32 is segmented but the belt 32 can alternatively be continuous. The belt 32 can be in the form of a track, a chain, or any other suitable form. An electric motor 36 is operably connected to one of the pulleys 34 with a drive belt 38 to rotate the pulley 34 and therefore rotate the belt 32 about the pulleys 34. The illustrated belt 32 and pulleys 34 are provided with cooperating teeth to decrease slippage therebetween. The illustrated embodiment is provided with three pulleys 34 but other quantities can be utilized within the scope of the present invention.

The manipulators 12 are secured to the belt 32 for rotation therewith. The illustrated manipulators 12 are roller type manipulators which extend outwardly and substantially perpendicularly from the belt 32. These roller-type manipulators have freely rotatable wheels to reduce friction along the kneading path. It is noted that other types of manipulators 12 can be utilized such as, for example, posts or casters. The manipulators 12 can also be alternatively provided with brakes or otherwise adapted to provide friction strokes as disclosed in U.S. patent application Ser. No. ______ , titled “Apparatus and Method For Applying a Friction Massage Stroke”, and filed the same day as the present invention, the disclosure of which is expressly incorporated herein in its entirety by reference.

The illustrated embodiment has five manipulators 12a, 12b, 12c, 12d, 12e equally spaced-apart along the length of the belt 32 but a fewer or greater number of manipulators 12 can be utilized within the scope of the present invention. Preferably, the manipulators are spaced along the belt 32 such that a subsequent manipulator 32 comes into contact with the user 40 before the previous manipulator disengages from the user 40. This spacing also allows the transfer assembly motor 36 to stop at a sensed position so that only one of the manipulators 12 is in static contact with the user 40. The translator 22 can then move the transfer assembly 14 in X, Y and/or Z axes to utilize the manipulator 12 in static contact as a conventional single roller manipulator. The device 30, therefore, has the flexibility to be used either as a kneading or conventional manipulator. The transfer assembly motor 36 of this massage device 30 is preferably separate from motors for other functions such as moving the translator 22. Having the dedicated motor 36, the transfer assembly 14 can move the manipulators 12 to generate, for example, a kneading pattern at computer-controlled rhythms, changing directions such as either kneading in the direction from toe to head or from head to toe, and/or stopping rotation of the belt 32 to generate static pressure. The transfer assembly can also include a weighing mechanism to determine breath phase of the user when the user is at least partially immersed in a liquid. The massage strokes can then be coordinated or synchronized with the breath phase of the user as disclosed in U.S. patent application Ser. No. ______ , titled “Manipulation Device With Buoyancy Breath Sensor”, and filed the same day as the present invention, the disclosure of which is expressly incorporated herein in its entirety by reference.

FIGS. 10 and 11 illustrate a massage device 42 according to a variation of the device according to the second embodiment of the present invention. The massage device 42 is substantially the same as the device 30 according to the second embodiment described above except as described herein below. Like references numbers are utilized to indicate like structure. The transfer assembly 14 is provide with four of the pulleys 34 and is further provided with a pair of perpendicularly oriented actuators 44 to control the position of two of the pulleys 34 which are secured thereto. The illustrated actuators 44 are in the form of electric linear actuators but the actuators can be of any suitable type such as, for example, pneumatic pistons and/or hydraulic pistons and also can be multi-axis actuators. It is noted that only one actuator can be alternatively utilized and that separate actuators 44 can be alternatively provided for some or all of the pulleys 34. The actuators 44 enable the pulleys 32 to be repositioned to change the shape of the belt 32 and therefore the stroke length at which the manipulators 12 engage the user 40.

FIGS. 12 and 13 illustrate a massage device 46 according to a third embodiment of the present invention. The massage device 46 according to the third embodiment is substantially the same as the device 30 according to the second embodiment except as described herein below and like references numbers are utilized to indicate like structure. The transfer assembly 14 includes pistons 48 connected to the pulleys 34 which are independently extended and retracted to reposition the pulleys 34. As noted above, by repositioning the pulleys 34, the shape of the belt 32 can be modified and thus the stroke length of the manipulators 12 can be modified. The illustrated device 46 includes three pistons 48, each secured to one of the three pulleys 34 but it is noted that fewer than all of the pulleys 34 can be alternatively provided with pistons 48. The pistons can be spring, pneumatic, hydraulic, or electric pistons which press the rotating transfer assembly into the user 40 with a nearly constant pressure. The combination of the rotating manipulators 12 with the pressuring pistons 48 produces a belt path in the general shape of an “D” which is elongated towards the apex of the arc.

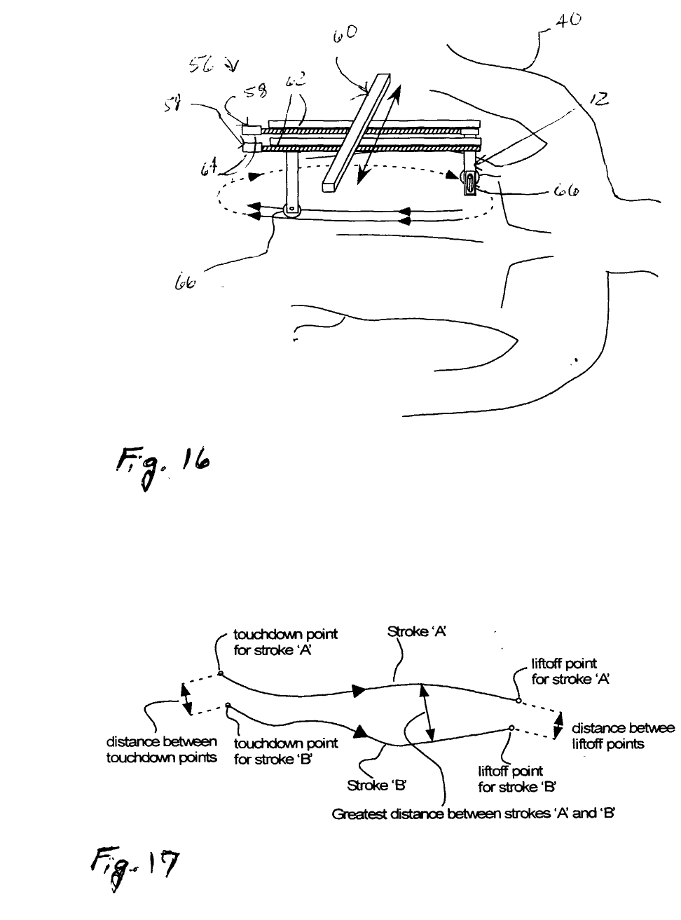

FIGS. 14 and 15 illustrate a massage device 50 according to variation of the massage device 46 according to the third embodiment of the present invention. The transfer device 14 includes a flexible spline backing 52 extending along a portion of the belt 32 on a side of the belt 32 opposite the manipulators 12 such that a portion of the belt 32, and any manipulators 12 located on that portion of the belt 32, are selectively bent outwardly by an extendable/retractable piston 54. The piston 54 is preferably controlled by the controller 28 such that more or less force can be selectively applied to the user 40 at various sections of the stroke contact path. This force variation is desirable to achieve a non-uniform force profile along the stroke path when desired.

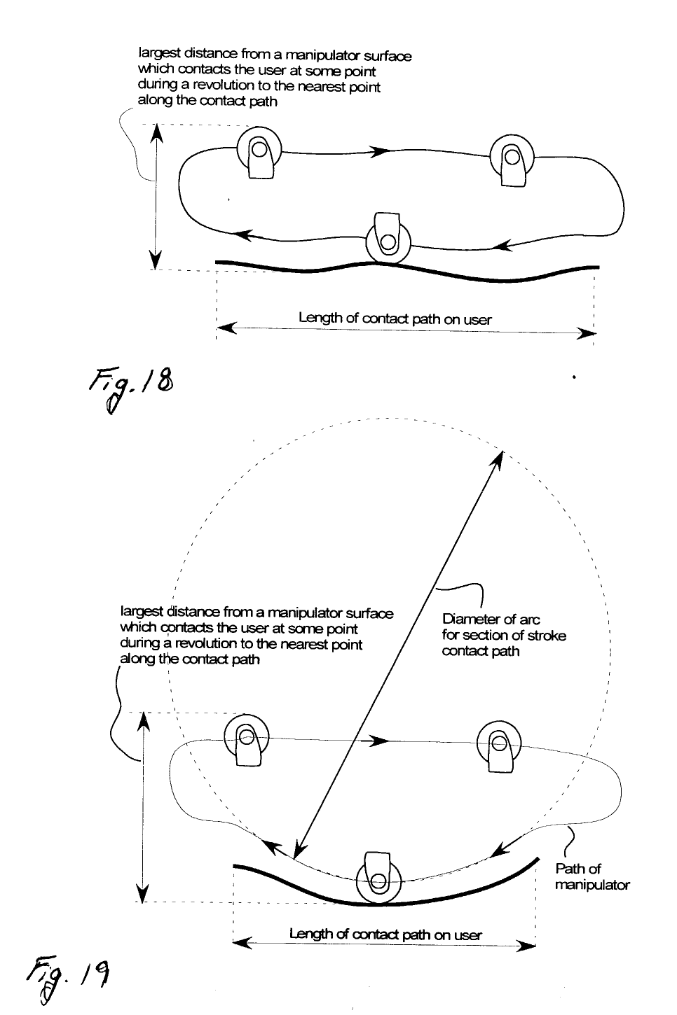

FIG. 16 illustrates a massage device 56 according to a fourth embodiment of the present invention. The massage device 56 according to the fourth embodiment is substantially the same as the devices 30, 46 according to the second and third embodiments except as described herein below and like references numbers are utilized to indicate like structure. The transfer assembly 14 is in the form of a pair of X axis linear actuators 58 each controlling longitudinal or X-axis movement of one manipulator 12 and an Y axis linear actuator 60 extending perpendicular to the X-axis linear actuators 58 and controlling lateral or Y-axis movement of the X-axis actuators 58 and the manipulators 12 secured thereto. The illustrated linear actuators 58, 60 each have separate drive screws 62 and separate electric drive motors 64 for rotating the drive screws 62. The manipulators 12 have retractable rollers 66, that is, at least the wheels of the rollers can be moved between extended and retracted positions whereby engagement and disengagement with the user 40 is obtained.

The controller 28 automatically operates the actuators 58, 60 and the retractable rollers 66 to obtain a desired open path of contact with the user. Dashed lines in FIG. 16 indicate the manipulators moving in the retracted position without contacting user while the solid lines indicate the manipulators 12 moving in the extended position and contacting the user 40. The X- and Y-axes actuators allow the controller 28 to move the kneading pattern anywhere on user's back with a variable contact path length. The contact path may be made to curve by translating the Y-axis actuator 60 during the stroke

As best shown in FIG. 17, a kneading massage can be provided with any of the above described devices 10, 30, 42, 46, 50, 56 which preferably includes at least a stroke A and a stroke B wherein the distance between the touchdown or engagement points of the two strokes are within about two inches and the liftoff or disengagement points of the two strokes are within about two inches. Additionally, the greatest distance between the two strokes is preferably about two inches. Furthermore, stroke A and stroke B preferably both have a total length of at least one half inch. Moreover, the engagement and disengagement points of each of stroke A and stroke B are preferably separated by at least one half inch. It is noted that when more than two manipulators are provided, and thus there are more than two stroke paths, the third or more stroke path preferably has the same relationships to stroke A and stroke B

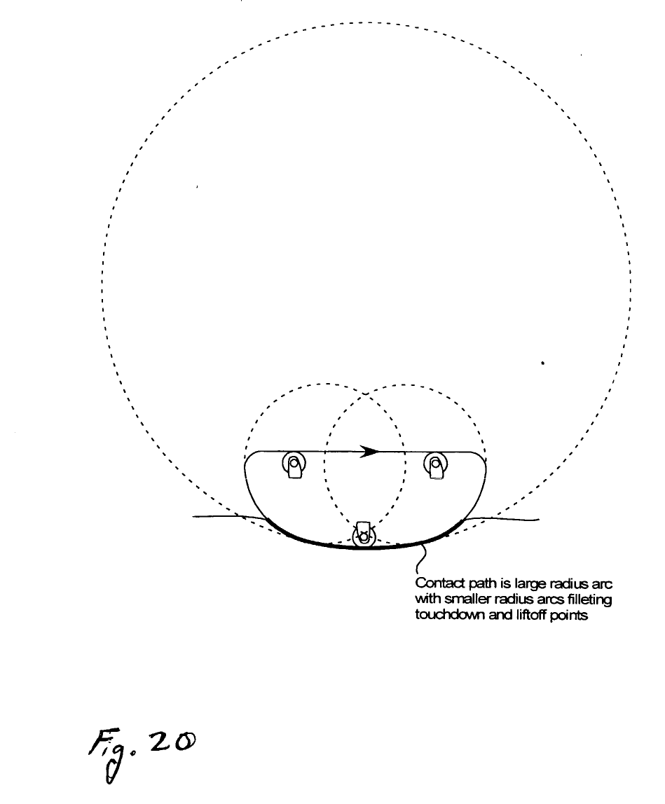

FIG. 18 illustrates a preferred geometric relationship that the largest distance from a surface of a manipulator 12 which contacts the user 40 at some point during a revolution to the nearest point along the contact path is smaller than the total length of the contact path.

FIG. 19 illustrates another preferred geometric relationship that the largest distance from a surface of a manipulator 12 which contacts the user 40 at some point during a revolution to the nearest point along the contact path is smaller than the diameter of an arc for a section of the contact path.

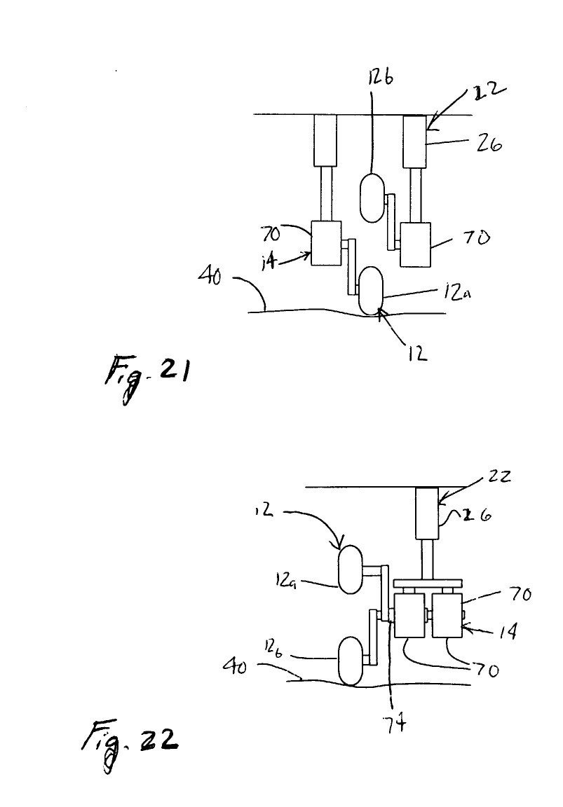

FIG. 20 illustrates yet another preferred geometric relationship that two changes in curvature define the stroke path: a relatively large diameter arc defining the central portion of the contact path and relatively small diameter arcs defining the engagement and disengagement ends of the stroke path. With the stroke path defined in this manner, the stroke path achieves sufficient penetration into the user 40 without having awkwardly long stroke length

FIG. 21 illustrates a massage device 68 according to a fifth embodiment of the present invention. The massage device 68 according to the fifth embodiment is substantially the same as the devices according to the first to fourth embodiments except as described herein below and like references numbers are utilized to indicate like structure. The transfer assembly 14 includes separate motors 70 for moving each of the manipulators 12. The illustrated manipulators 12 are rollers which are rotated or swing in a circular path by the motors 70. The motors 70 apply continuous kneading pressure to user 40. The motors can be controlled to speed up during “back swing” to quickly move from liftoff to touchdown position and hence be able to maintain continuous contact with user 40 with only two of the manipulators 12. The pistons 26 of the translator 22 are moved to change the pressure applied to the user 40.

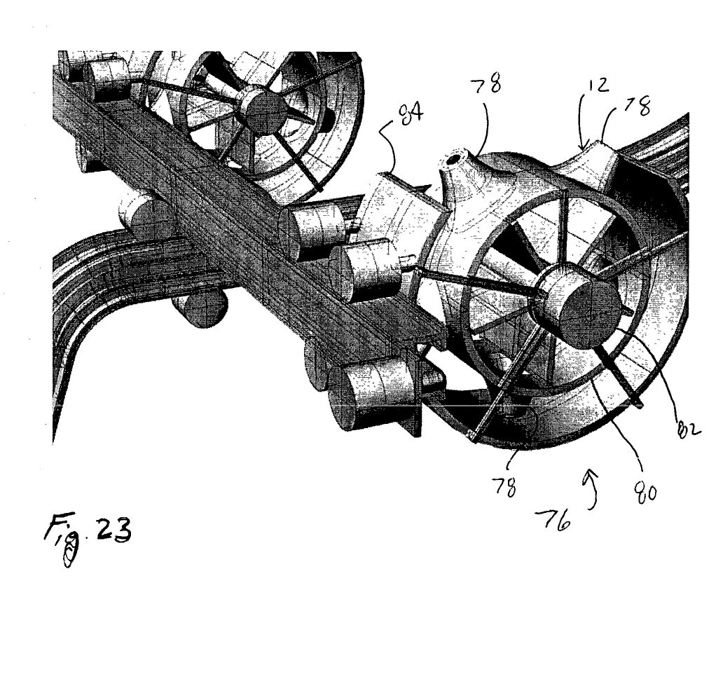

FIG. 22 illustrates a massage device 72 according to a variation of the fifth embodiment of the present invention. The massage device 72 is substantially the same as the device 68 according to the fifth embodiment except as described herein below and like references numbers are utilized to indicate like structure. The transfer device 14 includes separate motors 70 but the motors 70 are mounted coaxially with concentric shafts 74 so that a single piston 26 can be utilized to adjust the contact pressure for each manipulator. The motors 70 can be connected to the concentric shafts 74 through a right-angle gear to increase the clearance on the side of the rollers of the manipulators 12.

FIG. 23 illustrates a massage device 76 according to a sixth embodiment of the present invention. The massage device 76 according to the sixth embodiment is substantially the same as the devices according to the first to fifth embodiments except as described herein below and like references numbers are utilized to indicate like structure. The manipulator 12 is in the form of a nozzle 78 for forming a water stream or jet engaging the user 40. A plurality of the nozzles 78 are positioned about a rotatable wheel 80 which is driven by an electric motor 82. A baffle 84 extends partially about the wheel 80 to define the stroke length. The nozzles 78 are preferably spaced a distance apart such that a subsequent one of the nozzles 78 leaves the baffle 84 prior to the previous nozzle 78 entering the baffle 84. For a more detailed description of a suitable nozzle assembly, see U.S. patent application Ser. No. 09/560,370, filed on Apr. 28, 2000, the disclosure of which is expressly incorporated herein in its entirety by reference.

It is noted that each of the disclosed features of the various embodiments and variations can be utilized with each of the other disclosed embodiments and variations. For example, the translator sleds of the first embodiment can be used with the each of the other embodiments and the spline backing of the variation of the fifth embodiment can be utilized with any of the other embodiments having a flexible belt.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A massage device for manipulating a user, the device comprising, in combination:
a first manipulator adapted to engage the user;
a second manipulator adapted to engage the user;
a transfer assembly carrying the first and second manipulators and moving the first and second manipulators along successive first and second open paths of contact on the user respectively;
wherein the first and second open paths of contact each have engagement and disengagement points; and
wherein the engagement and disengagement points of the first open path of contact are each within about two inches of the engagement and disengagement points of the second open path of contact respectively.

2. The massage device according to claim 1, wherein the first and second open paths of contact each have a length of at least one-half inch.

3. The massage device according to claim 1, wherein at least one of the first and second open paths of contact has the engagement and disengagement points separated by at least one-half inch.

4. The massage device according to claim 1, wherein each of the first and second open paths of contact have the engagement and disengagement points separated by at least one-half inch.

5. The massage device according to claim 1, wherein all points along at least one of the first and second open paths of contact are within about two inches of the other of the first and second open paths of contact.

6. The massage device according to claim 1, further comprising a third manipulator adapted to engage the user, and wherein the transfer assembly carries the third manipulator and is adapted to engage the user with the third manipulator along a third open path of contact, the third open path of contact has engagement and disengagement points, and all points along the first and second open paths of contact are within about two inches of the third open path of contact.

7. The massage device according to claim 1, wherein the engagement and disengagement points of the first open path of contact are each within two inches of the engagement and disengagement points of the second open path of contact, respectively.

8. The massage device according to claim 1, wherein the first manipulator moves along a circular translation path including the first open path of contact and an open path of non-contact with the user, and wherein the largest distance between the first manipulator and a nearest point along the open path of contact at any point along the translation path is less than a length of the first open path of contact.

9. The massage device according to claim 1, wherein the first manipulator moves along a circular translation path including the first open path of contact and an open path of non-contact with the user, and wherein the translation path has a diameter which is at least 5% longer than the largest distance between the first manipulator and a nearest point along the open path of contact at any point along the translation path.

10. The massage device according to claim 1, wherein first and second crossed vectors form a plane, the first vector extends from the engagement point of the first open path of contact to the disengagement point of the first open path of contact, the second vector extends normal to the user at a midpoint of the first open path of contact, and the first open path of contact has at least one change in curvature when projected onto the plane.

11. The massage device according to claim 1, wherein first and second crossed vectors form a plane, the first vector extends from the engagement point of the first open path of contact to the disengagement point of the first open path of contact, the second vector extends normal to the user at a midpoint of the first open path of contact, and the first open path of contact has at least one section with a continuous change of curvature when projected onto the plane.

12. The massage device according to claim 1, wherein contact pressure exerted by the first and second manipulators on the user is constant within about 50% of maximum contact pressure along central portions of the first and second open paths of contact, and wherein the central portions of the first and second open paths of contact have lengths equal to about 80% of total lengths of the first and second open paths of contact, respectively.

13. The massage device according to claim 1, wherein contact pressure exerted by the first and second manipulators on the user is constant within about 25% of maximum contact pressure along central portions of the first and second open paths of contact, and wherein the central portions of the first and second open paths of contact have lengths equal to about 80% of total lengths of the first and second open paths of contact, respectively.

14. The massage device according to claim 1, wherein contact pressure exerted by the first and second manipulators on the user is constant within about 12% of maximum contact pressure along central portions of the first and second open paths of contact, and wherein the central portions of the first and second open paths of contact have lengths equal to about 80% of total lengths of the first and second open paths of contact, respectively.

15. The massage device according to claim 1, wherein the second manipulator engages the user along the second open path of contact prior to the first manipulator disengaging the user along the first open path of contact.

16. The massage device according to claim 1, wherein the first and second manipulators simultaneously engage the user at different points.

17. The massage device according to claim 1, wherein the first and second manipulators at times simultaneously engage the user at different points and at least one of the first and second manipulators engages the user at all times.

18. The massage device according to claim 1, wherein the transfer assembly is adapted to selectively change lengths of the first and second open paths.

19. The massage device according to claim 1, wherein at least one of the first and second open paths of contact is curved.

20. The massage device according to claim 19, wherein the transfer assembly is adapted to selectively change curvature of at least one of the first and second open paths of contact.

21. The massage device according to claim 1, wherein the transfer assembly is adapted to selectively change a direction of motion of the first and second manipulators.

22. The massage device according to claim 1, further comprising a translator carrying the transfer assembly and adapted to move the transfer assembly along at least one axis relative to the user.

23. The massage device according to claim 22, wherein the transfer assembly is adapted to selectively change lengths of the first and second open paths, at least one of the first and second open paths of contact is curved, and the transfer assembly is adapted to selectively change curvature of at least one of the first and second open paths of contact.

24. The massage device according to claim 1, wherein the massage device is a hand tool.

25. The massage device according to claim 1, wherein the transfer device includes a drive mechanism and a controller operably connected to the drive mechanism to automatically move the first and second manipulators.

26. The massage device according to claim 1, wherein the transfer device includes a drive mechanism having separate first and second motors with concentric axes.

27. The massage device according to claim 1, wherein the first and second manipulators are rollers and are adapted to apply a shear force to the user.

28. The massage device according to claim 1, further comprising means for changing a pressure intensity of the first and second manipulators.

29. The massage device according to claim 1, wherein the first and second manipulators are water jets.

30. The massage device according to claim 1, wherein the transfer assembly includes a weighing mechanism for determining a breadth phase of the user.
